(19) United States
(12) Patent Application Publication
(10) Pub. No.: US 2007/0199868 A1
(43) Pub. Date: Aug. 30, 2007

(54) Wastewater Purification Method

(75) Inventor: Patrick John Volpe, Hawthorn (AU)

Correspondence Address: BUCHANAN, INGERSOLL & ROONEY PC, POST OFFICE BOX 1404, ALEXANDRIA, VA, 22313-1404, US

(73) Assignee: AQUENOX PTY LTD., Hawthorn (AU)

(21) Appl. No.: 10/573,286

(22) PCT Filed: Sep. 23, 2004
(86) PCT No.: PCT/AU04/01299

§ 371 Date: Dec. 19, 2006

(30) Foreign Application Priority Data
Sep. 23, 2003 (AU) 2003905176

(51) Int. Cl. C02F 1/48; B01D 21/30

(52) U.S. Cl. 210/143; 210/167.31; 210/748

(57) ABSTRACT

A process to purify wastewater that comprises the steps of passing the wastewater through an electrocoagulation cell which comprises a plurality of reaction plates or electrodes (6) disposed within said cell and spaced apart from each other, whereby said wastewater is treated by passing an electric current through the wastewater to thereby produce purified water (8); re-using said purified water for cleaning or other purposes to produce wastewater; and recycling (3) the wastewater back to the electrocoagulation cell. The wastewater may be obtained public or household showers, sinks, basins, baths, washing machines, dishwashers, kitchens or car washes.

### FIELD OF INVENTION

This invention is concerned with a method and apparatus for purifying wastewater streams such as that from public and domestic showers, baths and wash basins, launderettes, restaurants, vehicle garages including vehicle service facilities and car washes, hotels, ships and aeroplanes. In particular, the invention relates to a method of purifying and recycling wastewater for human re-use.

### BACKGROUND OF THE INVTION

Water is an invaluable commodity and most regions of the world are faced with a limited resource of fresh, consumable water. Therefore treatment and recycling of wastewater is an increasingly essential utility worldwide and in conditions where water is at a premium, such as geographical areas that have very little rainfall, ships and aeroplanes, water recycling is essential.

Water restrictions are frequently imposed on domestic users and commercial institutions by the government. In situations of water shortage the water supply may only be available for one to two hours a day. However, even if sources of fresh water are readily available, water conservation and recycling are ecologically preferred options and also provide substantial cost benefits.

There are many industries that produce large amounts of wastewater, such as industrial launderettes, hotels, cruise ships, aeroplanes, petrochemical industry (car washes) and hospitals. Such wastewater would contain contaminants such as detergents, oils, greases, suspended matter, petrochemicals, biological and non-biological organic compounds, and food and beverage waste. Often the wastewater is discharged to the mains which results in wastage of such wastewater.

U.S. Pat. No. 4,812,237, in the name of Cawley and Mercer, describes a water purification and recycling system for processing domestic wastewater. The system comprises septic tanks, a sand filter, an ultrafilter, a disinfection unit and water quality and quantity sensors to monitor and control the process. This system is designed for domestic use and relatively small amounts of water, and the water would take a long time to pass through the system. Therefore it is not suitable for large amounts of wastewater that have to be purified rapidly, for example in a commercial situation, such as a hotel, hospital or commercial car wash.

U.S. Pat. No. 5,147,532, in the name of Kenneth Leek, also describes a water purification system for wastewater from domestic appliances. This is also a complicated system comprising screen, sediment, carbon and colour filters, an ultraviolet radiation unit and a storage tank. This system is designed for domestic and not commercial use and would not efficiently process large volumes of water.

U.S. Pat. No. 4,802,991, in the name of George Miller, describes a water purification process particularly suitable for purifying water containing fatty acids. The purification apparatus comprises an inlet conduit, electrolysis chamber, flocculation chamber and a monitoring device. The flocculation chamber has a conical shape and is located directly above the electrolysis chamber and is in direct contact with the electrolysis chamber. The electrolysis and flocculation chambers comprise a moving bed of solid non conductive particles, such as granite, having a specific density greater than that of the water to be purified. The wastewater is passed upwards through the electrolysis chamber and the moving bed of particles, past the electrodes into the flocculation chamber. As the water passes into the flocculation chamber the moving bed of particles falls back into the electrolysis chamber past the electrodes under the force of gravity. This allows efficient and constant self-cleaning of the electrodes. The monitoring device monitors the degree of pollution of the wastewater and comprises a light source and sensor which reacts to variations in water turbidity.

This type of purification system is not suitable for treating wastewater comprising particles or a high grease or oil content. The particles or thick oil would become trapped in the moving bed of particles, which would prevent efficient purification of the water.

In summary, the prior art suffers from a significant disadvantage in that there is a substantial wastage of wastewater, and purification systems such as U.S. Pat. No. 5,147,532 cannot process large volumes of water. Other purification systems, such as U.S. Pat. No. 4,802,991, are extremely complicated in structure. U.S. Pat. No. 4,812,237, while it refers to recycling of wastewater in a closed circuit cannot process large volumes of water and thus could not be used in commercial or industrial installations.

### SUMMARY OF THE INVENTION

It is an object of the invention to provide a purification process for water that alleviates the disadvantages of the prior art. Unexpectedly, the inventors have ascertained that large volumes of wastewater can be purified using an electrocoagulation cell thereby providing an endless source of purified water. The purified water may be harnessed for cleaning, or other useful operations, and the wastewater so produced can be recycled through the electrocoagulation cell and re-used.

In a first aspect, the invention provides a method of purifying wastewater that includes the steps of:
(i) passing the wastewater through an electrocoagulation cell which comprises a plurality of reaction plates or electrodes disposed within said cell and spaced apart from each other whereby said wastewater is treated by passing an electric current through the wastewater to thereby produce purified water;
(ii) re-using said purified water for cleaning or other purposes to produce wastewater; and
(iii) recycling the wastewater back to the electrocoagulation cell.

Prior to step (i) the wastewater may be obtained from public or household showers, sinks, basins, baths, washing machines, dishwashers, kitchens or car washes and may be initially stored in a collection tank or sump.

Prior to step (i) the wastewater may be filtered prior to electrocoagulation treatment to remove large particles from the wastewater. Preferably, particles with a size greater than 200 μm are removed. The wastewater may also be passed through one or a plurality of pre-treatment tanks which allow the removal of heavy oils, sludge and fuel, if present, in the wastewater.

Preferably, direct current (DC) is applied to the reaction plates or electrodes of the electrocoagulation cell. This has the advantage of using a smaller number of electrodes than is the case of alternating current.

The electrocoagulation cell is preferably orientated vertically so that the outlet conduit is located at the top of the reaction chamber and the inlet conduit is located at the bottom of the reaction chamber. However, this does not preclude the use of an electrolytic cell arranged horizontally, such as described in, for example, WO 96/28389 or in U.S. Pat. No. 5,611,907. It is also possible for the water to be circulated throughout the cell in a serpentine fashion in either a vertical or horizontal orientation.

The electrocoagulation cell may comprise any number of electrodes or reaction plates but at least two are used which are electrically coupled to the power supply.

Preferably, the voltage applied to the electrodes falls within the range 10-110 volts. More preferably, the voltage falls within the range 20-80 volts and even more preferably, 20-60 volts.

Preferably, the current applied to the electrodes falls within the range 2-100 amps. More preferably, the current falls within the range 5-60 amps and even more preferably, 5-20 amps.

The electrodes can be manufactured from any metal, for example, aluminium, steel, titanium, steel, brass and iron. Preferably, aluminium or titanium electrodes are used. Also 2-75 electrodes in the electrocoagulation cell can be used. Of these electrodes, 2-26 may be connected to the power supply. Preferably, 2-8 electrodes are connected.

Preferably, a flow rate of 2-1000 L/min is used. More preferably, a flow rate of 5-200 L/min and even more preferably 10-50 L/min is used.

The purified water is discharged into one or a plurality of settling tanks for separation of the contaminated floc from the purified water. The settling tanks can be connected to a rainwater collection tank to allow collected rainwater to be discharged into the settling tanks to increase the volume of water available for recycling.

Preferably, after step (i) the purified water is passed through a filter to remove particles. Preferably, the filter removes particles with a size greater than 10 μm.

Suitably, after step (i), the purified water maybe filtered and passed through a reverse osmosis system prior to re-use, to further purify the water.

In step (ii) the purified water can be stored in a storage tank before re-use. After re-use the water may be collected and stored in a collection tank or sump.

In a second aspect, the invention provides a closed circuit system for processing wastewater that includes:
(i) a treatment zone comprising an electrochemical cell for processing wastewater so as to produce purified water;
(ii) an application zone for application or use of the purified water for cleaning or other operations which produce wastewater; and
(iii) a recycling zone for recycling the wastewater back to the electrocoagulation cell.

The treatment zone may include one or more of the following apparatus:
(a) one or a plurality of pre-treatment tanks;
(b) one or a plurality of settling or coagulation tanks;
(c) a collection tank for the collection of rainwater;
(d) one or a plurality of filters; and
(e) a reverse osmosis system.

The application zone may include a storage tank or sump.

The recycling zone may include a collection conduit for recycling wastewater back to the electrocoagulation cell and a storage tank or sump.

Throughout this specification, “comprise”, “comprises” and “comprising” are used inclusively rather than exclusively, will be understood to imply the inclusion of a stated integer or group of integers but not the exclusion of any other integer or group of integers.

### BRIEF DESCRIPTION OF THE DRAWINGS

Reference may now be made to a preferred embodiment of the invention as shown in the attached drawings wherein:

FIG. 1 is a schematic drawing of a water purification plant showing the process steps that can be applied to wastewater from a car wash.

FIG. 2 is a schematic drawing showing an electrocoagulation electrode configuration and its connection to a power supply.

### DETAILED DESCRIPTION OF INVENTION

For the purposes of this invention, by “wastewater” is meant any type of water obtained from car washes and commercial and domestic washing machines, dishwashers, showers, baths and sinks.

The wastewater can contain contaminants such as suspended solids, oils, grease, dissolved metals and detergents.

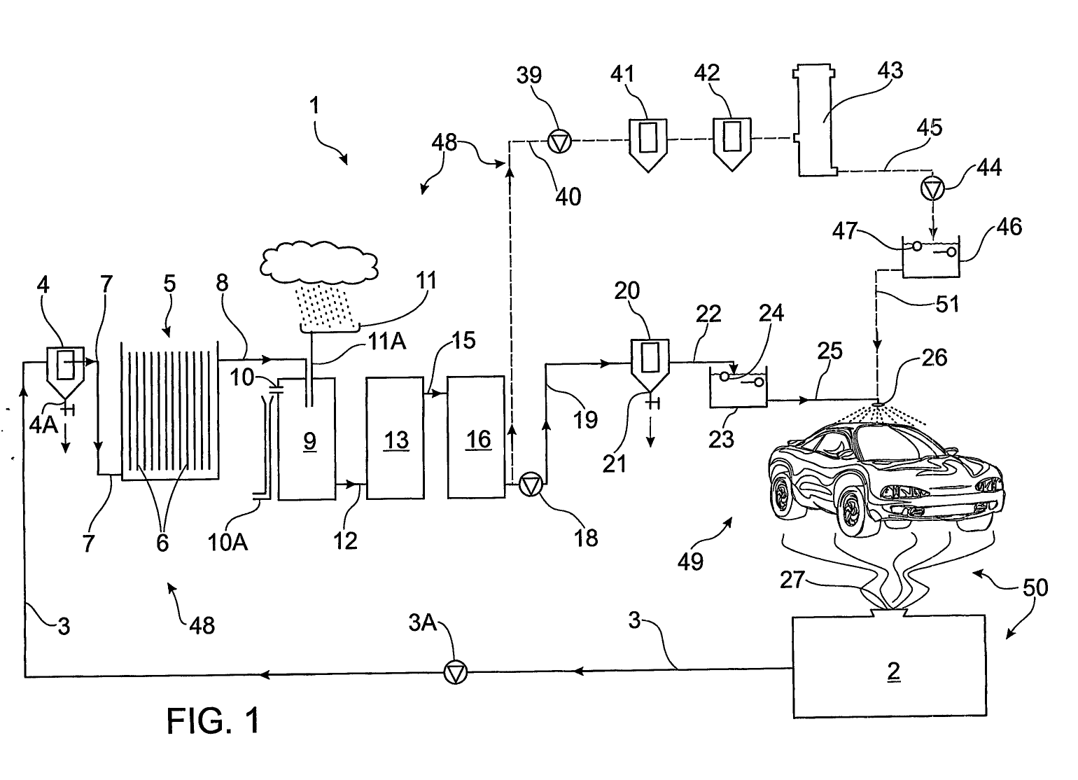

FIG. 1 shows a schematic drawing of water purification plant 1 which may be applied to wastewater obtained from a car wash.

Water purification plant 1 includes three zones, wastewater treatment or purification zone 48, application zone 49 and recycling zone 50.

Water from sump 2 is transferred or pumped through conduit 3 into filter 4. Filter 4 removes suspended particles with a size greater than 200 μm. The solids from the filter underflow are collected and disposed through conduit 4A.

Prior to passing of the wastewater through filter 4 the wastewater may be passed through one or a plurality of pre-treatment tanks (not shown) or a triple interceptor. The pre-treatment tanks or triple interceptor allow the removal of heavy oils, sludge and fuel, if present, from the wastewater.

The liquid overflow from filter 4 is transferred through conduit 7 into electrocoagulation cell 5. Conduit 7 may have a flow control valve (not shown). Pump 3A can create variable flow rates of water into electrocoagulation cell 5.

Electrocoagulation cell 5 comprises a plurality of reaction plates 6. The wastewater enters electrocoagulation cell 5 through an inlet conduit (7) preferably located at the bottom of the electrocoagulation cell.

After electrocoagulation treatment in electrocoagulation cell 5, the water is discharged through conduit 8 into coagulation or settling tank 9. The treated water is discharged through an outlet conduit (8) preferably located at the top of electrocoagulation cell 5. The overflow of froth and oil can drain through conduit 10, which is preferably located in the top of tank 9. The overflow is disposed through conduit 10A. Rainwater collected in collection tank 11 may also be transferred through conduit 11A into coagulation or settling tank 9.

The water may then be transferred into coagulation or settling tank 13 through conduit 12 and then into settling or holding tank 16 through conduit 15. Settling tanks 13 and 16 may also have an overflow conduit (not shown) to allow any remaining froth or oil to be discharged.

The wastewater is passed through pump 18 through conduit 19 to filter 20. Filter 20 removes suspended particles with a size greater than 10 μm. The solids from the filter underflow are collected and disposed through conduit 21.

The liquid overflow from filter 20 is transferred through conduit 22 into storage tank 23. Storage tank 23 may comprise ball valve control 24 that controls water inflow and outflow of tank 23. The purified water is transferred to the car wash water supply pipes through conduit 25. The water can be ejected through one or a plurality of manual or mounted hose outlets or sprinklers, or a high-pressure gun 26 onto the vehicle to be washed.

If further purification of the treated or purified wastewater is required, the wastewater can be pumped from settling tank 16 to reverse osmosis system 43. The water is pumped by pump 39 to reverse osmosis system 43 via conduit 40 and one or more filters 41 and 42. Prior to reverse osmosis treatment the wastewater may also be passed through one or more treatment systems (not shown), for example, a water softening system and/or a de-chlorination system.

After reverse osmosis treatment the water is pumped by pump 44 via conduit 45 to storage tank 46. Storage tank 46 may comprise ball valve control 47 that controls water inflow and outflow of tank 46. The purified water is transferred to the car wash water supply pipes through conduit 51. The water can be ejected through one or a plurality of manual or mounted hose outlets or sprinklers, or a high-pressure gun 26 onto the vehicle to be washed.

Dirty wastewater is then collected through a drainage system located beneath 20 the parked vehicle (not shown) and channelled into collection conduit 27. Conduit 27 transfers the wastewater into sump 2 for recycling through water purification plant 1.

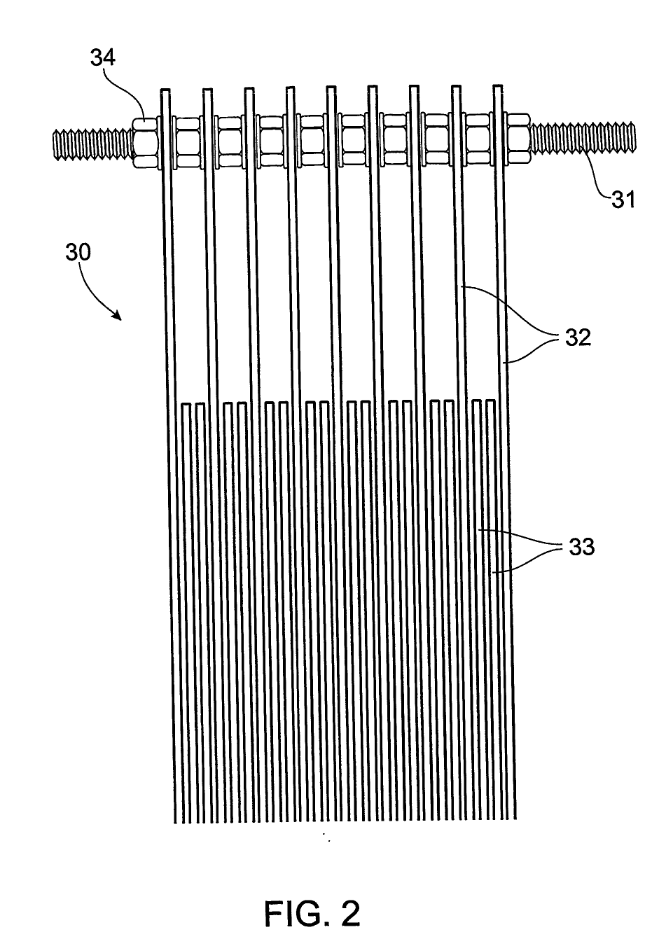

FIG. 2 shows an example of an electrocoagulation electrode (reaction plate) configuration 30 and its connection to a power supply 31. There are 25 flat plate electrodes in total; nine unipolar electrodes 32 that are connected to DC power supply 31 and sixteen bipolar electrodes 33. An electric current is passed through the water in electrocoagulation cell 5 to induce an electrochemical reaction occurs whereby metal ions released from the electrodes and water anions released from the water cause coagulation in the wastewater and destabilize colloidal suspensions from aqueous solutions. The floc binds or absorbs other impurities present in the wastewater and serves as a transport medium to remove impurities from the water.

A description of an electrocoagulation cell is provided in International Patent Publication No. WO 01/53568 and U.S. Pat. No. 6,139,710. The precipitation or suspension (floc) can be removed through separation techniques, such as sedimentation, filtration and natural or electrolytic flotation.

Electrodes are connected to the DC power source via suitable cables and a bus bar arrangement 31, which is bolted directly onto each unipolar electrode 32 by bolts 34. For effective purification of the wastewater, an optimum current and voltage may be applied via the electrodes to the water. The current and voltage values are dependent on the following critical parameters;
(i) number of electrodes used;
(ii) total wetted surface area of electrodes in the cell;
(iii) number of electrode connections to a DC power source;
(iv) size of the gap between the electrodes;
(v) pH of the water;
(vi) conductivity of the water;
(vii) the concentration and types of contaminants in the wastewater; and
(viii) flow rate and cell residence time of the wastewater through the cell.

Preferably, the conductivity of the wastewater is measured before the process is set up and conductivity variations are measured regularly throughout use of the process. Preferably, the electrocoagulation cell parameters are set up taking into consideration the minimum conductivity value. Conductivity variations for car wash wastewater are typically very low. However, the conductivity of laundry or dishwashing wastewater can vary considerably, and therefore conductivity values should be measured more regularly.

The optimum parameters can be determined experimentally by a skilled person. If a fixed water flow rate is used, a critical factor in determining the current and voltage values is the cell configuration, i.e. the number of electrodes in the cell, the gap between the electrodes and the number of electrodes that are connected to a DC power source. Preferably, parameters such as the flow rate, number of electrodes in the cell, the size of the gap between the electrodes and the number of electrodes that are connected to a DC power supply will be fixed. Preferably, the reaction plates extend across the width or length of electrocoagulation cell 5 and each side of the electrode is contacted by the water to allow maximum contact with the water flowing through the cell (total wetted surface area of cell).

Preferably, if a low flow rate is used (2-30 L/min), a smaller cell design with a lower number of electrodes and less total power (voltage and current) is required. If a high flow rate is used (for example, 1000 L/min or greater), a larger cell design with greater than 20 electrodes is required, more preferably 50-75 electrodes.

Other important factors are the linear velocity of the solution through the cell and the cell residence time. Cell residence time depends on the flow rate of water and the type of flow through electrocoagulation cell 5, for example, laminar or serpentine flow. Preferably, the following characteristics of water flow through the cell are used:
(i) laminar flow;
(ii) linear flow velocity,
(iii) orientated solution entry at the bottom of the cell; and
(iv) solution output vertically above the solution entry point and at the top of the cell.

The power system controlling the electrocoagulation system may be automated to facilitate precise control and to provide flexibility in controlling electrocoagulation cell 5.

Purification plant 1 and the associated power system may also be automated. Flow control valves and sensors may also be incorporated into the plant.

Preferably, purification plant 1 and associated power system is designed to be compact and portable to facilitate transport to and use in a variety of locations. Preferably, it can be mounted on ground engaging wheels or a skid, or even installed underground, for example, underneath a car wash or under a house. There also may be provided a generator for providing electrical power to power supply 14.

Filters 4, 20, 41 and 42 can be any type of filter, such as a belt press, bag, carbon bed, sand, and plate and frame type filters. Preferably, a filter media is used which is easily cleaned or replenished enabling minimal downtime of the system.

Valve 24 can be any type of check valve which incorporates a biasing member such as a spring which when biased away from a valve seat opens a valve orifice located in a valve chamber for passage of fluid. The spring is usually associated with a movable valve member such as a ball. Alternatively a swing and lift valve may be used.

Preferably, if an electrocoagulation cell comprises 8-75 electrodes with a gap of 3 mm between each electrode and 2-26 electrode connections to a DC power source, the voltage applied to the electrocoagulation cell falls within the range 10-110 volts (DC) and the current may fall within the range of 2-100 amps. These values will of course be dependent upon the varying characteristics of the sample matrix of the wastewater.

The wastewater may remain in settling tanks 9, 13 and 16 for a variable amount of time. Preferably, the wastewater remains in each tank for 20-60 minutes, more preferably, 30-40 minutes.

Preferably, no chemicals are used in the process. However, in some circumstances it maybe necessary to add chemicals for (i) conductivity modification or standardisation; (ii) for pH control (in cases of high or low pH wastewater); and (iii) addition of poly-electrolyte solutions to the wastewater after electrocoagulation treatment in settling tanks 9, 13 and 16 to accelerate contaminant coagulation.

Modifications may be made to the purification process. Any of the pre-treatment or post-treatment steps may be omitted subject to the nature or composition of the wastewater.

Use of the pre-treatment (or a triple interceptor) tanks may be required, for example, in manual car washes and vehicle service facilities wherein the wastewater may comprise fuel, sludge and heavy oils. This may occur if car maintenance, such as oil changing and radiator fluid changing, is carried out in the area. Purification of wastewater from automatic car washes may not require use of the pre-treatment tanks,

Reverse osmosis treatment of the wastewater may be required if the wastewater, having passed through the electrocoagulation cell requires further purification. For example, if a spot-free rinse finish is required for the car wash or dish wash, or if pure or distilled water is required by hospitals, the wastewater can be subjected to reverse osmosis treatment. It maybe required that the wastewater is also subjected to de-chlorination and water softening treatment.

The coagulation and holding tanks, filters and electrocoagulation cell should be cleaned regularly.

If the system remains idle for greater than 24 hours the treated water in the coagulation and holding tanks can be returned to sump 2 for a second pass through the electrocoagulation cell. Alternatively, an ultraviolet or aerating system can be incorporated into the coagulation and holding tanks to prevent growth of bacteria in the water.

While the invention has been described with particular reference to a purification process for wastewater obtained from a car wash it will be understood that, in a modified form, the invention may also be used for the purification of water obtained from washing machines, dishwashers, showers, baths and sinks from domestic homes, hotels, restaurants, ships, aeroplanes or hospitals. Different voltage and current values and different electrocoagulation cell design may be required for effective water purification depending on the composition of the wastewater and the flow rate of the wastewater through the system.

Application zone 49 may also be a cleaning zone and the wastewater produced by the cleaning zone (also known as grey water) comprises detergents and cleaning agents.

Used wastewater from one or a plurality of washing machines, dishwashers, sinks or showers can be collected in conduit 27 and transferred to sump 2. The wastewater can then be purified as described above and is stored in storage tank 23 before being recycled through conduit 25 to one or a plurality of the abovementioned washing machines or water outlets.

So that the invention may be more readily understood and put into practical effect, the skilled person is referred to the following non-limiting examples.

### EXAMPLES

The following examples were carried out using a bench-type electrocoagulation system.

### Example 1

he following example applies to an EC system for the removal of shower and washbasin contaminants from a wastewater sample.
Contaminants present in sample—suspended solids (dirt), TP (total phosphorous-detergents)
The sample was grey-coloured water with soap suds and dirt in solution. There were some suspended particles and the sample was stirred sample stirred while treated.
The raw sample had a pH of 5.4 and conductivity 780 μS/cm.
Flow rate: 1 L/min
   Experimental Results

The most successful treatment was achieved using the following parameters:
Electrode type: Aluminium
Number of electrodes=8
Number of connections=4 (electrodes 1, 3, 6, 8)
Volts=35
Amps=4.8
Coagulant produced—light density foam coagulant and a very clear aqueous layer.
Very effective removal of dirt and detergents was observed.
Water re-cycling is an option for the treatment process.
The sample was treated without any adjustment of pH or conductivity.

### Example 2

The following example applies to an EC system for the removal of restaurant discharge contaminants (food and fats) from a wastewater sample.
Contaminants present in sample—suspended solids, total phosphorous (TP—detergents), food, oil and grease (cooking oils), BOD (biological oxygen demand—food proteins), total Kjeldahl Nitrogen (TKN—nutrients).
The sample was grey/brown-coloured water with food particles in solution.
Preferably, the sample is pre-filtered prior to treatment.
The raw sample had a pH of 5.5 and conductivity 1,150 μS/cm.
Flow rate: 1 L/min
   Experimental Results
The most successful treatment was achieved using the following parameters:
Electrode type: Aluminium
Number of electrodes=8
Number of connections=4 (electrodes 1, 3, 6, 8)
Volts=50
Amp=9.5
Coagulant produced—high density/large volume foam coagulant due to the high BOD content. Fats and greases were also removed. There was a very clear aqueous layer. Method was highly successful.
Water re-cycling is an option for the treatment process.
The sample was treated with an adjustment to pH. The conductivity was high due to food salts in the sample.

### Example 3

The following example applies to an EC system for the removal of engine oil contaminants from a wastewater sample from a car service facility.
Contaminants present in sample—suspended solids, TP (detergents), car oil and grease (engine oils), petrochemicals and dissolved metals.
The sample was a brown/black emulsion, oil/grease emulsion with dirt and detergents in solution.
The raw sample had a pH of 6.8 and conductivity 490 μS/cm.
Flow rate: 1 L/min
   Experimental Results
The most successful treatment was achieved using the following parameters:
Electrode type: Aluminium
Number of electrodes=8
Number of connections=4 (electrodes 1, 3, 6, 8)
Volts=51
Amps=3.0
Coagulant produced—high density/low volume coagulant
Oils and greases, dirt and other components were removed.
There was a very clear aqueous layer. Therefore the method was successful
Water re-cycling is an option for the treatment process.
The treatment method works across a broad range of pH and conductivity.

### Example 4

The following example applies to an EC system for the purification of drain water from trade waste.
Contaminants present in sample—oil, grease and suspended solids.
The sample was an oil/grease emulsion with dirt and detergents in solution.
The raw sample had a pH of 7.7 and conductivity 1260 μS/cm.
Flow rate was 1 L/minute.
   Experimental Results
The most successful treatment was achieved using the following parameters:
Electrode type: Aluminium
Number of electrodes=8
Number of connections=4
Volts=33
Amps=11
Detergents, oils and greases, dirt and other components were removed.

### Example 5

The following example applies to an EC system for the purification of water contaminated with oil.
Contaminants present in sample—oil
The sample was an oil/grease emulsion
The raw sample had a pH of 5.6 and conductivity 1090 μS/cm.
Flow rate was 1 L/minute.
   Experimental Results
The following treatment was successful using the following parameters:
Electrode type: Aluminium
Number of electrodes=8
Number of connections=8
Volts=10
Amps=10
The oil was removed to leave a clear aqueous layer.

The advantages of the wastewater purification process of this invention are as follows:
(i) the process recycles and conserves water, drastically reducing the amount of water used on a daily basis;
(ii) the process allows the rapid treatment of large volumes of water;
(iii) the system is automated, compact and portable;
(iv) electrocoagulation separates rather than destroys wastewater contaminants and produces a low volume, aqueous stable sludge that is readily separated from a liquid stream for subsequent disposal;
(v) the process is an essentially chemical-free process;
(vi) the process can perform effectively the simultaneous treatment of multiple contaminants;
(vii) the process is suitable for all types of car wash systems, for example, automatic, semi-automatic and manual systems;
(viii) rainwater can be collected and used in the process; and
(ix) the process saves money by reducing water bills.

1. A method of purifying wastewater including the steps of:
(i) passing the wastewater through an electrocoagulation cell which comprises a plurality of reaction plates or electrodes disposed within said cell and spaced apart from each other, whereby said wastewater is treated by passing an electric current through the wastewater producing an electrochemical reaction which generates a floe in the electrocoagulation cell, whereby the floe binds or absorbs impurities present in the wastewater;
(ii) passing the wastewater containing said floc having bound thereto said impurities into a coagulation tank or settling tank whereby said floc is discharged from the tank to produce purified water without addition of flocculant or coagulant to the wastewater or use of an additional separating device such as a magnetic separator;
(iii) re-using said purified water for cleaning or other purposes to produce wastewater; and
(iv) recycling the wastewater back to the electrocoagulation cell.

2. A method of purifying wastewater from a vehicle wash facility including the steps of:
(vii) collecting wastewater from a first vehicle being cleaned in said facility in a tank or sump;
(viii) transferring said. wastewater from the tank or sump to an electrocoagulation cell;
(ix) passing the wastewater through an electrocoagulation cell which comprises a plurality of reaction plates or electrodes disposed within said cell and spaced apart from each other, whereby said wastewater is treated by passing an electric current through the wastewater producing an electrochemical reaction which generates a floe in the electrocoagulation cell, whereby the floe binds or absorbs impurities present in the wastewater;
(x) passing the wastewater containing said floc having bound thereto said impurities into a coagulation tank or settling tank whereby said floe is discharged from the tank to produce purified water without addition of flocculant or coagulant to the wastewater;
(xi) re-using said purified water for cleaning a second vehicle in said facility to produce wastewater; and
(xii) recycling the wastewater back to the electrocoagulation cell.

3. The method of claim 1 or claim 2 wherein froth and oil from the wastewater is discharged from the settling or coagulation tank adjacent the top thereof by gravity.

4. The method of claim 1 or claim 2 wherein the wastewater is filtered prior to passing the wastewater through an electrocoagulation cell to remove large particles, if present, from the wastewater

5. The method of claim 4 wherein particles with a size greater than 200 μm are removed.

6. The method of any one of claims 1 to 4 wherein the wastewater is passed through one or a plurality of pre-treatment tanks to remove heavy oils, sludge and fuel, if present, from the wastewater.

7. The method of claim 1 or claim 2 wherein direct current is applied to the reaction plates or electrodes of the electrocoagulation cell.

8. The method of claim 1 or claim 2 wherein the electrocoagulation cell is orientated vertically so that an outlet conduit is located at the top of the electrocoagulation cell and an inlet conduit is located at the bottom of the electrocoagulation cell.

9. The method of claim 1 or claim 2 wherein the voltage applied to the electrodes falls within the range 10-110 volts.

10. The method of claim 9 wherein the voltage applied to the electrodes falls within the range 20-80 volts.

11. The method of claim 9 wherein the voltage applied to the electrodes falls within the range 20-60 volts.

12. The method of claim 1 or claim 2 wherein the current applied to the reaction plates or electrodes falls within the range 2-100 amps.

13. The method of claim 12 wherein the current applied to the reaction plates or electrodes falls within the range 5-60 amps.

14. The method of claim 12 wherein the current applied to the reaction plates or electrodes falls within the range 5-20 amps.

15. The method of claim 1 or claim 2 wherein the electrodes are manufactured from a metal selected from the group consisting of aluminium, steel, iron, titanium, silver and brass.

16. The method of claim 15 wherein the electrodes are manufactured from aluminium or titanium.

17. The method of claim 1 or claim 2 wherein 2 to 75 electrodes are used in the cell.

18. The method of claim 17 wherein 2 to 26 of the electrodes are connected to the power supply.

19. The method of claim 1 or claim 2 wherein the flow rate of wastewater through the electrocoagulation cell falls within the range 2-1000 L/min.

20. The method of claim 19 wherein the flow rate falls within the range 5-200 L/min.

21. The method of claim 19 wherein the flow rate falls within the range 10-50 L/min.

22. The method of claim 1 or claim 2 wherein the purified wastewater is discharged into one or a plurality settling tanks for separation of contaminated flo, if present, from the purified wastewater.

23. The method of claim 22 wherein the settling tanks are connected to a rainwater collection tank to allow collected rainwater to be discharged into the settling tanks to increase the volume of water available for recycling.

24. The method of claim 1 or claim 2 wherein the purified wastewater is filtered prior to re-use.

25. The method of claim 24 wherein particles with a size greater than 10 μm are removed.

26. The method of claim 1 or claim 2 wherein the purified water is stored in a storage tank before re-use.

27. The method of claim 1 or claim 2 wherein the purified water is stored in a sump after re-use.

28. The method of claim 1 or claim 2 wherein after the wastewater has passed through the coagulation or settling tank the wastewater is passed through a reverse osmosis system.

29. The method of any one of claims 1, 2 or 26 wherein the wastewater is passed through a de-chlorination system after the wastewater has passed through the coagulation or settling tank.

30. The method of any one of claims 1, 2, 28 or 29 wherein the wastewater is passed through a water softening system after the wastewater has passed through the coagulation or settling tank.

31. The method of claim 1 wherein prior to step (i) the wastewater may be obtained from public or household showers, sinks, basins, baths, washing machines, dishwashers, kitchens or car washes and may be initially stored in a collection tank or sump.

32. A closed circuit system for purifying wastewater from a vehicle wash facility comprising:
(i) a wastewater collection zone for collection or drainage of wastewater obtained from cleaning vehicles;
(ii) an electrocoagulation cell comprising a plurality of reaction plates or electrodes spaced apart from each other for processing wastewater so as to produce a floc in the electrocoagulation cell whereby the floc binds or absorbs impurities present in the wastewater;
(iii) a coagulation or settling tank for separating the floc from the purified water; and
(iv) an application zone for application or use of the purified water for cleaning vehicles.

33. The system of claim 32 wherein the system includes one or a plurality of pre-treatment tanks for the removal of fuel, sludge and heavy oils, if present, from the wastewater upstream of the electrocoagulation cell.

34. The system of claim 32 wherein the coagulation or setting tank includes a collection tank for the collection of rainwater.

35. The system of any one of claims 32 to 34 wherein the system includes one or a plurality of filters upstream of the electro coagulation cell.

36. The system of any one of claims 32 to 35 wherein the system includes a reverse osmosis system downstream of the settling or coagulation tank.

37. The system of any one of claims 32 to 36 wherein the system includes a water softening system downstream of the settling or coagulation tank.

38. The system of any one of claims 32 to 37 wherein the system includes a de-chlorination system downstream of the settling or coagulation tank.

39. The system of claim 32 wherein the application zone includes a storage tank or sump.

40. The system of claim 32 wherein the application zone is a cleaning zone and the wastewater or grey water produced in said cleaning zone contains detergents and cleaning agents.

41. The system of claim 32 wherein the system includes a collection conduit for recycling the wastewater back to the electrocoagulation cell upstream of the wastewater collection zone.

42. The system of claim 32 and claim 41 wherein the collection zone includes a storage tank or sump.

43. The system of claim 32 wherein the system is automated.
